(19) United States
(12) Patent Application Publication
(10) Pub. No.: US 2019/0154052 A1
(43) Pub. Date: May 23, 2019

(54) BUSHING FOR ROTARY FLUID PUMPING EQUIPMENT

(71) Applicant: OPTIMAL PUMP SOLUTIONS INC., CALGARY (CA)

(72) Inventor: CHRISTOPHER SEAN PATTON, CALGARY (CA)

(73) Assignee: OPTIMAL PUMP SOLUTIONS INC., CALGARY (CA)

(21) Appl. No.: 16/098,970

(22) PCT Filed: May 5, 2017
(86) PCT No.: PCT/CA2017/050548

§ 371 Date: Nov. 5, 2018

(30) Foreign Application Priority Data
May 6, 2016 (CA) 2929281

(51) Int. Cl. F04D 29/12; F16J 15/16; F16J 15/18

(52) U.S. Cl. CPC F04D 29/128; F16J 15/183; F16J 15/162

(57) ABSTRACT

A throat bushing for use in a seal chamber or stuffing box of rotary fluid equipment is provided. The throat bushing includes a first face; a second face; an outer annular surface spanning between the first second faces and dimensioned to be received within a bore of the seal chamber or stuffing box; and an inner annular surface defining an inner bore extending from the first face to the second face, the inner bore dimensioned to receive a rotary shaft and permit rotation of the shaft therein. The throat bushing further includes at least one arced groove traversing the inner annular surface from the first face to the second, the arced groove being open to the inner bore along its length and defining a substantially semi-helical path leading from an opening of the arced groove on the first face to an exit of the arced groove on the second face.

### CROSS-REFERENCE TO RELATED APPLICATIONS

This application claims priority to PCT Application No. PCT/CA2017/050548, having a filing date of May 5, 2017, based on Canadian Application No. 2,929,281, having a filing date of May 6, 2016, the entire contents both of which are hereby incorporated by reference.

### FIELD OF TECHNOLOGY

The following relates generally to throat bushings employed by rotary fluid equipment. More specifically, the following relates to throat bushings comprising at least one arced groove being open to, and extending along, an inner bore of the throat bushing.

### BACKGROUND

Pumps are workhorses of many industrial plants and processes. Fluid pumps are used in, for example, sewer and wastewater management, mining operations, pulp and paper plants, in the oil and gas industry, and in many other applications where fluid must be moved. For several reasons, pumps which require less flush water during operation are preferred. Grit, other particulate, and air in the pump seal chamber can cause a myriad of problems for a pump operator. Excessive particulate may lead to wear and tear within the seal chamber, leading to a decrease in pump performance, leakage, and/or eventual pump failure. Likewise, air caught within the chamber may cause excessive heat build-up, causing the pump to run hot to the point where flush water can no longer provide sufficient cooling.

Traditional throat bushings are well-known and commonly employed within the pump housings of centrifugal pumps and other such rotary fluid equipment. They are typically provided to form a restrictive close clearance around the motor shaft or shaft sleeve, in order to separate the impeller in the pump chamber, or volute, from the seal chamber or stuffing/packing box. The throat bushing will be located between the seal and the impeller in the case of mechanical seal applications, or between the impeller and rings of packing, or stuffing, in the case of stuffing box applications.

The main function of the seal chamber/stuffing box is to control the amount of fluid leaking along the motor shaft to the atmosphere. It also prevents air from working along the shaft to the pumping chamber of the pump housing. Frequently the seal chamber/stuffing box will require a source of flush water for cooling and lubricating the seal faces or packing and the motor shaft/shaft sleeve. However, in applications where the fluid being pumped contains abrasives or particulate matter, the requirement for flush supply is much greater. This presents several problems during pump operation. For instance, the flush water supply may become contaminated and require treatment. Additionally, if the pumpage contains a high level of abrasive or particulate matter, large volumes of flush water may be required to increase the lifetime of the mechanical seal or packing and reduce costly repair and pump down-time. However, this is only marginally effective.

Devices have been developed in an effort to alleviate or reduce flushing demands, particulate matter and air trapping in the pump seal chamber or stuffing box during pump operation, and/or improve fluid transfer within the seal chamber to reduce heat build-up. PCT application publication no. WO 2007/059599, for example, describes throat bushings comprising at least one tangential channel therethrough leading tangentially from a first face of the throat bushing proximal to an outer surface, through to a second face of the throat bushing proximal to an inner annular surface of a bore of the throat bushing. The tangential channel bored or otherwise formed in the throat bushing is an enclosed passage which is separate from the bore of the throat bushing.

The entrapment of particulate matter and air within the pump seal chamber or stuffing box of rotary fluid pumping equipment remains a common problem. Air/particulate removal systems, which may increase the lifetime of the seal or packing and/or may reduce costly repair and pump down-time, are desirable. There may also be a significant environmental and/or economic benefit to be realized by reducing the amount of water or fluid needed to flush the seal chamber or stuffing box in such applications, as well as by reducing the energy usage of the pump equipment due to reduced heat build up.

An alternative, additional, and/or improved throat bushing for use in a seal chamber or stuffing box of rotary fluid equipment may be desirable.

### SUMMARY

An aspect relates to a throat bushing for use in a seal chamber or stuffing box of rotary fluid equipment, said throat bushing comprising:
a first face;
a second face;
an outer annular surface spanning between the first face and the second face and dimensioned to be received with a tight fit within a throat or bore of said seal chamber or stuffing box;
an inner annular surface defining an inner bore extending from the first face to the second face, the inner bore dimensioned to receive a rotary shaft with clearance to permit free rotation of said rotary shaft therein; and
at least one arced groove traversing the inner annular surface from the first face to the second face, the arced groove being open to the inner bore along its length and defining a substantially semi-helical path leading from an opening of the arced groove located on the first face to an exit of the arced groove located on the second face.

In another embodiment of a throat bushing as described above, the throat bushing may be configured such that:

the opening of the arced groove extends across the first face from the inner annular surface toward the outer annular surface;

the exit of the arced groove extends across the second face from the inner annular surface toward the outer annular surface; and

the opening of the arced groove is dimensioned to approach the outer annular surface more closely than the exit of the arced groove.

In yet another embodiment of any of the throat bushing or bushings above, the throat bushing may comprise more than one arced groove, the substantially semi-helical paths of which are all left-handed directionality or all right-handed directionality thereby matching a rotational turn of the rotary shaft.

In still another embodiment of any of the throat bushing or bushings above, the throat bushing may comprise an outer vent traversing the outer annular surface from the first face to the second face.

In another embodiment of any of the throat bushing or bushings above, the throat bushing may comprise an outer drain traversing the outer annular surface from the first face to the second face, the outer drain being located on the outer annular surface substantially opposite the outer vent.

In yet another embodiment of any of the throat bushing or bushings above, the inner annular surface of the throat bushing may comprise a tapered portion starting within the inner bore between the first face and the second face and tapering annularly outward to the first face.

In still another embodiment of any of the throat bushing or bushings above, the inner annular surface of the throat bushing may comprise a first annular chamfer around the interface between the inner annular surface and the first face.

In yet another embodiment of any of the throat bushing or bushings above, the inner annular surface of the throat bushing may comprise a shaft clearance portion which defines an inner diameter (ID) of the inner bore, the ID being dimensioned to receive said rotary shaft with clearance to permit free rotation of said rotary shaft therein.

In another embodiment of any of the throat bushing or bushings above, the first face of the throat bushing may include a second annular chamfer around the outer circumference thereof.

In still another embodiment of any of the throat bushing or bushings above, at least a portion of the inner bore of the throat bushing may be tapered, progressively narrowing from the first face to the second face.

In another embodiment, there is provided herein a use of any of the throat bushing or bushings above in a rotary fluid pump.

In still another embodiment, there is provided herein a rotary fluid pump comprising any of the throat bushing or bushings above.

In yet another embodiment, there is provided herein a kit comprising any of the throat bushing or bushings above.

In still another embodiment of a kit as described above, the kit may further comprise instructions for installing the throat bushing in a seal chamber or stuffing box of rotary fluid equipment.

In yet another embodiment of any of the kit or kits described above, the kit may further comprise a lantern ring paired to the dimensions of the throat bushing, for use within the stuffing box of rotary fluid equipment.

In another embodiment of any of the kit or kits described above, the kit may further comprise one or more stuffing rings for use within the stuffing box of rotary fluid equipment.

In yet another embodiment, there is provided herein a method of manufacturing any of the throat bushing or bushings above, comprising machining into a throat bushing said at least one arced groove into said inner annular surface thereof using a rounded ball endmill.

In still another embodiment, there is provided herein a method of manufacturing a rotary fluid pump comprising:
installing any one of the throat bushing or bushings above into the a seal chamber or stuffing box of the rotary fluid pump by inserting said throat bushing into a throat of the seal chamber or stuffing box.

In another embodiment of a method of manufacturing a rotary fluid pump as described above, the method may further comprise a step of removing a previously installed throat bushing, if present, from the seal chamber or stuffing box of the rotary fluid pump.

### BRIEF DESCRIPTION

Some of the embodiments will be described in detail, with references to the following Figures, wherein like designations denote like members, wherein:

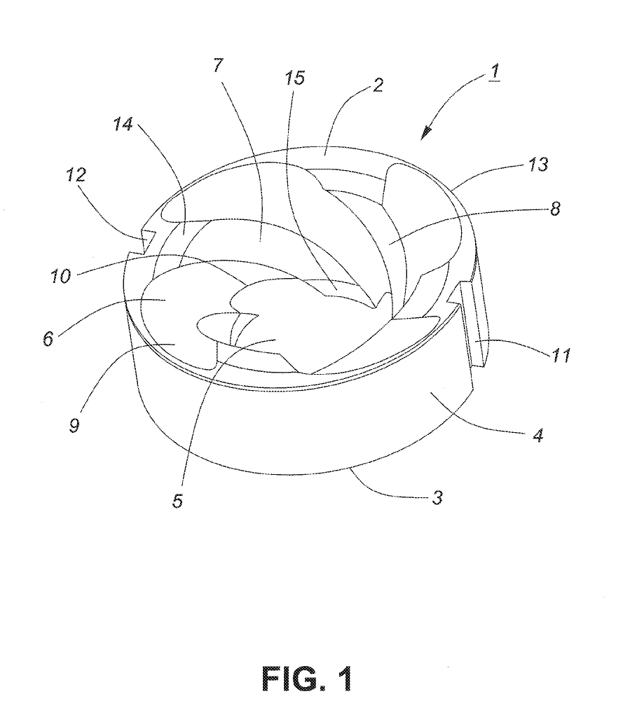

FIG. 1 shows a perspective view of an example of a throat bushing as described herein, adapted for use within a pump seal chamber or stuffing box;

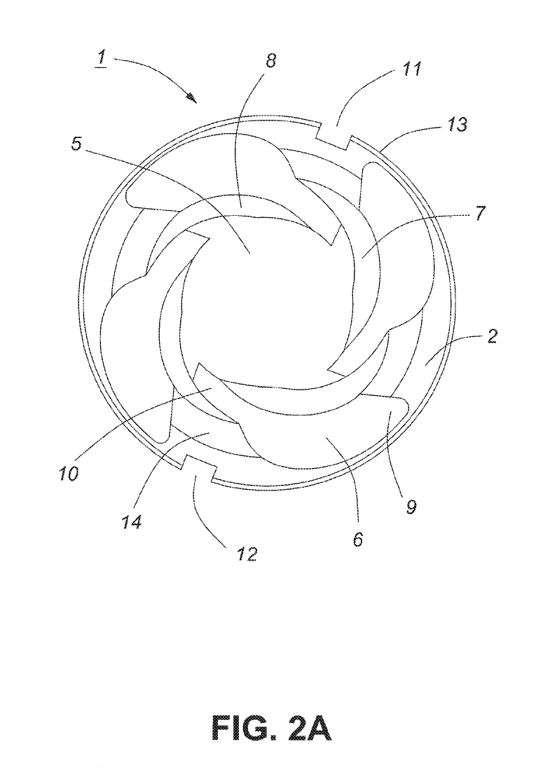

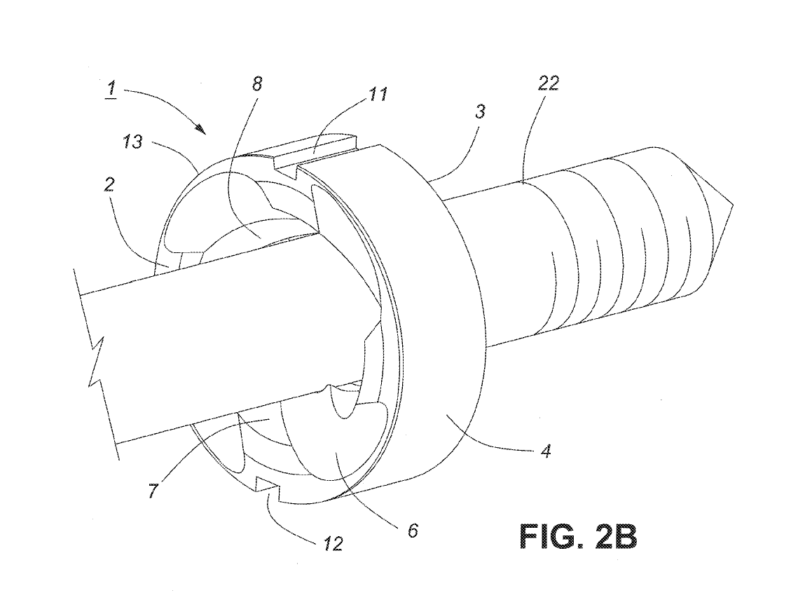

FIG. 2A shows a top plan view of the throat bushing of FIG. 1, showing the seal-facing side;

FIG. 2B shows a perspective view of the seal-facing side of the throat bushing of FIG. 1, with a rotary shaft passing through its inner bore;

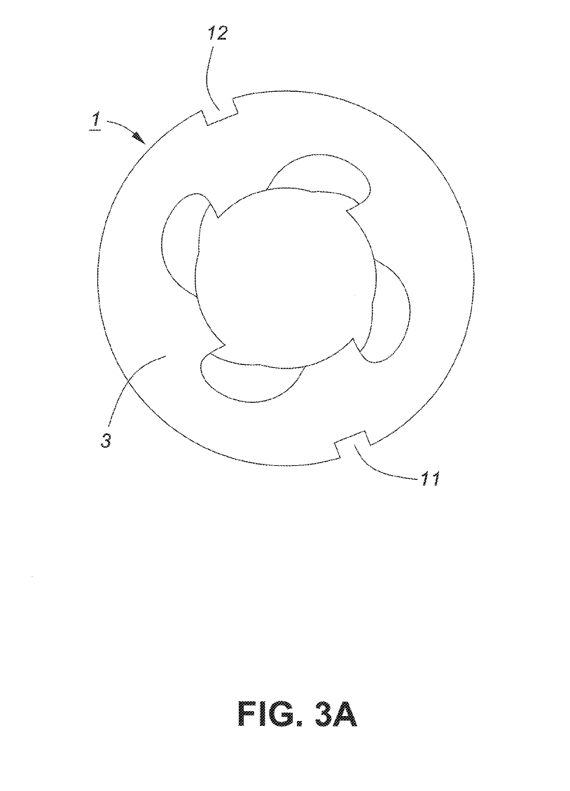

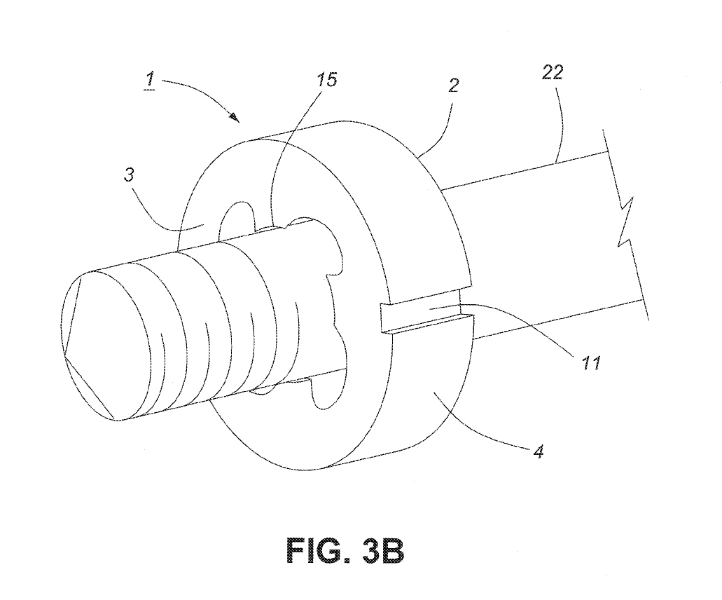

FIG. 3A shows a bottom plan view of the throat bushing of FIG. 1, showing the impeller-facing side;

FIG. 3B shows a perspective view of the impeller-facing side of the throat bushing of FIG. 1, with a rotary shaft passing through its inner bore;

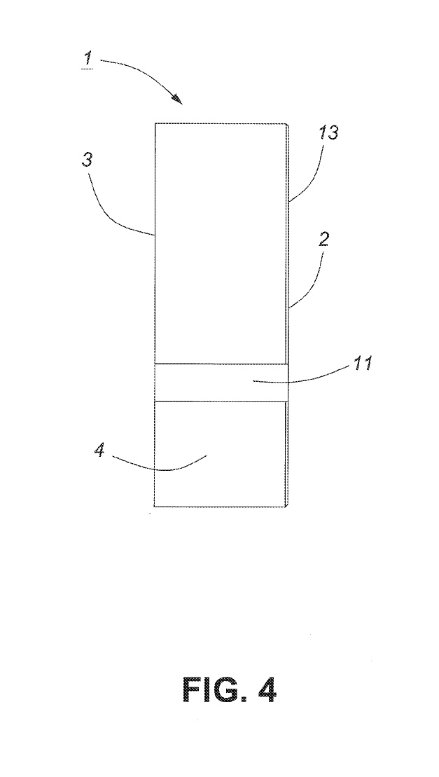

FIG. 4 shows a side elevational view of the throat bushing of FIG. 1;

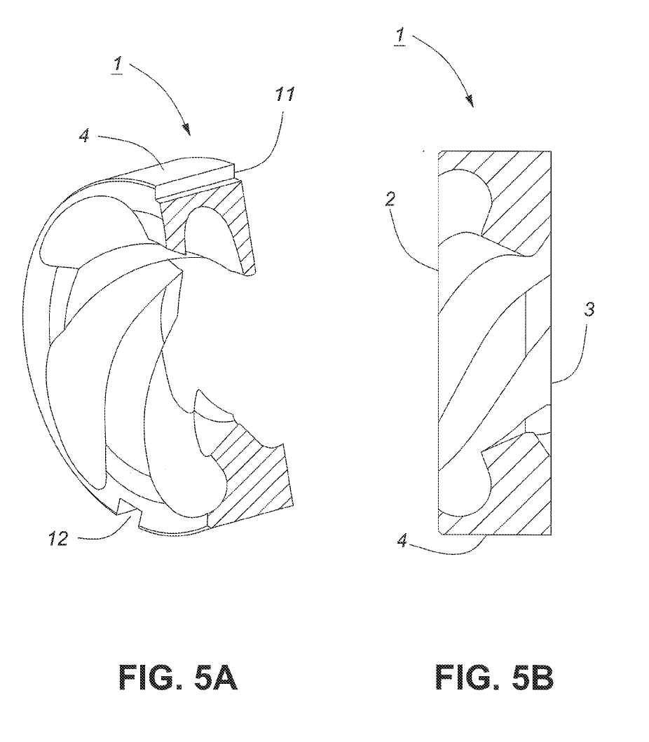

FIG. 5A shows a cross-sectional perspective view of the throat bushing of FIG. 1;

FIG. 5B shows a cross-sectional side view of the throat bushing of FIG. 1;

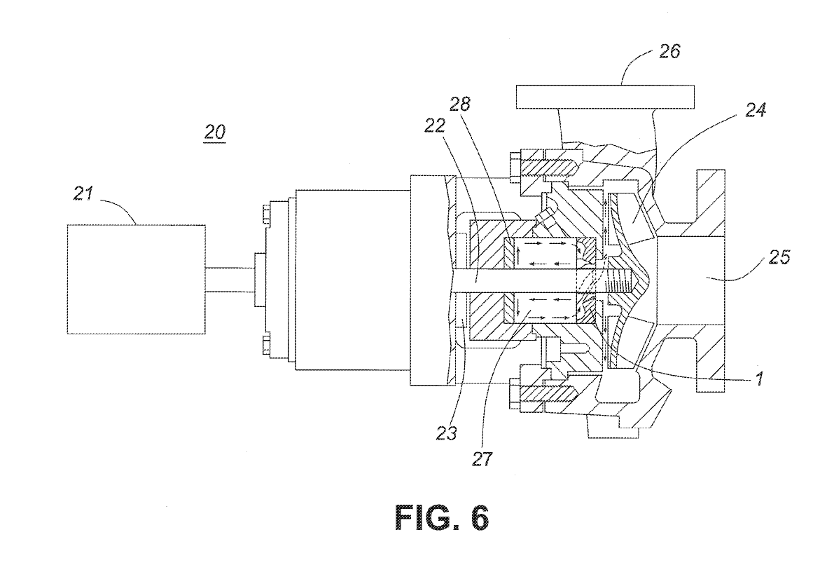

FIG. 6 shows a partial cross-sectional side view of a throat bushing as described herein, positioned within the throat of the seal chamber of a centrifugal pump;

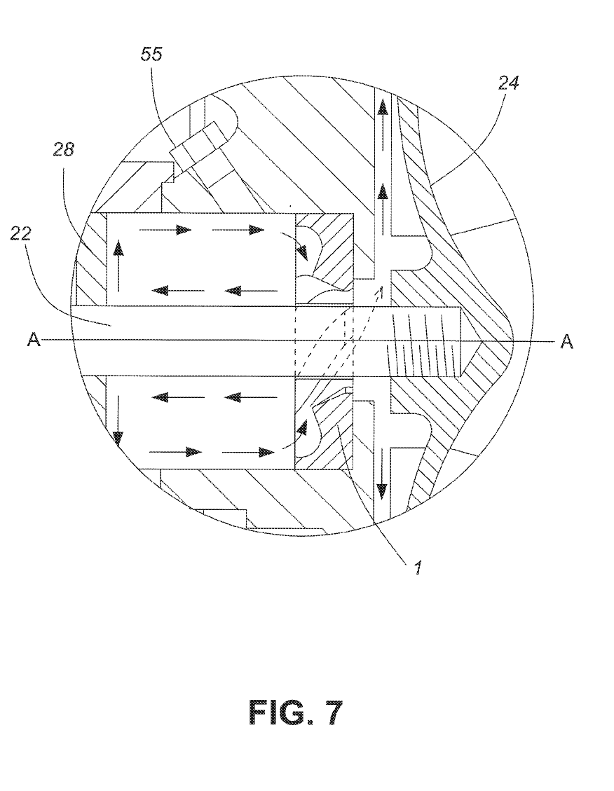

FIG. 7 shows an enlarged partial cross-sectional side view of the pump seal chamber and throat bushing shown in FIG. 6;

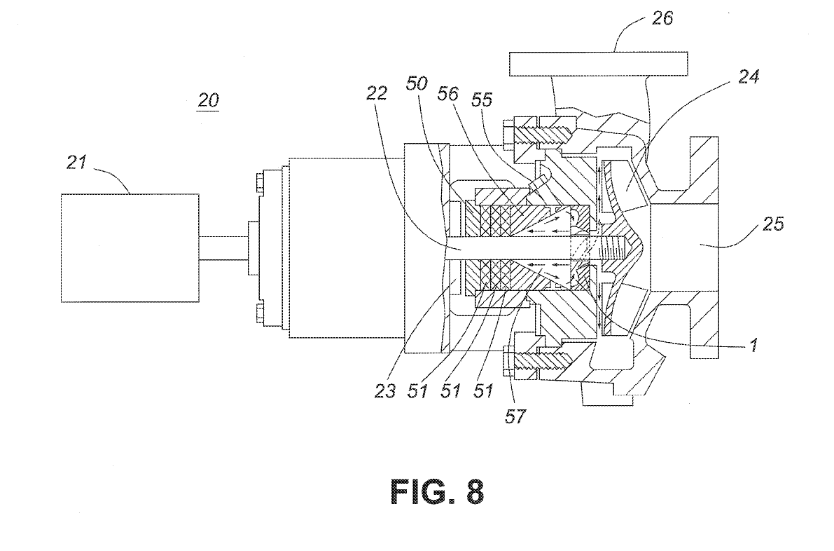

FIG. 8 shows a partial cross-sectional side view of a throat bushing as described herein, positioned within the throat of the stuffing box of a centrifugal pump which includes a lantern ring and rings of packing; and

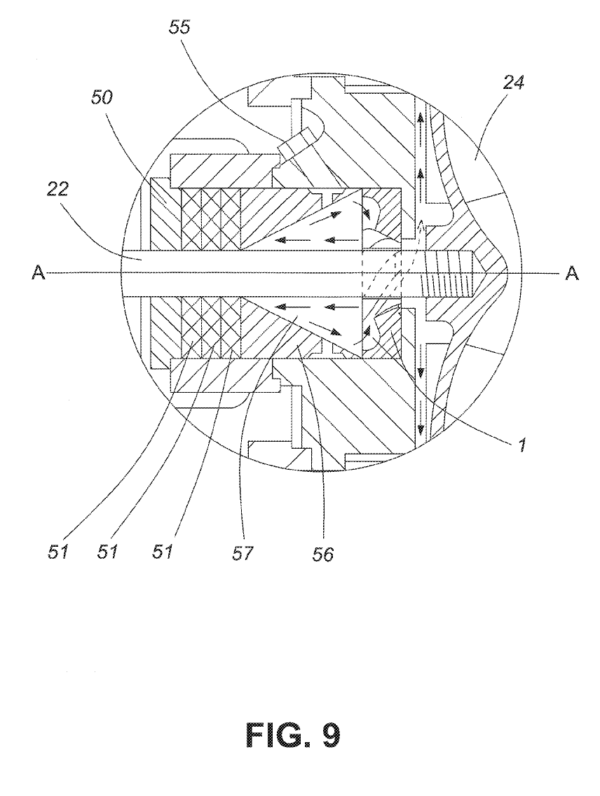

FIG. 9 shows an enlarged partial cross-sectional side view of the stuffing box and throat bushing as shown in FIG. 8.

### DETAILED DESCRIPTION

Throat bushings are commonly employed in the pump housing of centrifugal pumps and other such rotary fluid equipment. Described herein are throat bushings comprising at least one arced groove being open to, and extending along, an inner bore of the throat bushing. Such throat bushings may be used, for example, in the seal chamber or stuffing box of rotary fluid equipment. An arced groove design as described herein may reduce flushing requirements and/or may extend the amount of time between repairs in certain applications. Arced grooves may facilitate the evacuation of particulate matter trapped in the pump seal chamber or stuffing box, back out towards the volute of the pump housing.

In certain embodiments, a throat bushing as described herein may be used to reduce the amount of flush typically required in pumping applications involving fluid dispersed particulates, or slurries. In certain further embodiments, a throat bushing as described herein may be used reduce the amount of particulate matter and/or air that becomes trapped in the pump seal chamber or stuffing box during operation of centrifugal pumps and other such rotary fluid equipment. In certain other embodiments, a throat bushing as described herein may allow improved fluid transfer within the seal chamber or stuffing box and/or reduced heat build-up, potentially allowing the seal to operate cooler and/or for longer periods with a significant reduction in energy consumption.

It will be appreciated that embodiments and examples are provided herein for illustrative purposes intended for those skilled in the art, and are not meant to be limiting in any way.

FIG. 1 shows a perspective view of an example of a throat bushing as described herein, adapted for use within a pump seal chamber or stuffing box. In the throat bushing illustrated in FIG. 1, the throat bushing (1) is adapted for use in, for example, a seal chamber or stuffing box of rotary fluid equipment. The illustrated throat bushing example comprises:
a first face (2) which faces a seal chamber when installed;
a second face (3) which faces an impellor when installed;
an outer annular surface (4) spanning between the first face (2) and the second face (3) and dimensioned to be received with a tight fit within a throat or bore of said seal chamber or stuffing box;
an inner annular surface (8) encircling an inner bore (5) extending from the first face (2) to the second face (3), the inner bore (5) being dimensioned to receive a rotary shaft with clearance to permit free rotation of said rotary shaft therein; and
at least one arced groove (6) traversing the inner annular surface (8) from the first face (2) to the second face (3), the arced groove (6) being open to the inner bore (5) along its length and defining a substantially semi-helical path leading from an opening of the arced groove (9) located on the first face (2) to an exit of the arced groove (10) located on the second face (3).

The at least one arced groove (6) may be machined, or otherwise formed, in the throat bushing (1), so as to lead from the first face (2) on the seal side (also referred to herein as a seal face), through to the second face (3) on the impeller side (also referred to herein as an impeller face) in a directional manner to complement the flow pattern caused by the rotational force of the rotary shaft during operation thereof. The illustrated arced grooves (6) are open to the inner bore (5) along its length, and define a substantially semi-helical path leading from an opening of the arced groove (9) located on the first face (2) to an exit of the arced groove (10) located on the second face (3) in a semicircular-type fashion.

As shown in the illustrative embodiment in FIG. 1, the arced grooves may be substantially semi-circular in cross-section at their exits (10) on the second face (3), and are typically uniform in diameter moving toward the first face (2).

A substantially semi-helical path as referred to herein may also be considered a partial twist-like path, wherein the arced groove defines a curving or arcing fluid pathway having a 3-dimensional clockwise or counter clockwise directionality progressing along its length.

As will be understood by the person of skill in the art having regard to the teachings herein, upon assembly of a throat bushing as described with a rotary shaft, the one or more arced grooves (6) may form one or more fluid pathway(s) leading from the seal chamber or stuffing box to the pump chamber behind the impeller. The outer cross-sectional perimeter of each fluid pathway may be partially bounded by arced groove (6), with substantially the remaining portion of the outer cross-sectional perimeter of each fluid pathway being bounded by the rotary shaft exterior as will be further understood having regard to FIGS. 2 and 3, in particular FIGS. 2(B) and 3(B). Where present, a tapered portion (7) and/or first (14) and/or second (13) annular chamfers as described below may additionally contribute to defining the outer cross-sectional perimeter of each fluid pathway, as will be understood having regard to FIGS. 1-5 and the following descriptions thereof.

Previously developed and described throat bushings having drilled straight holes do not take advantage of rotating flow patterns (i.e. rotational flow and velocity vectors) in seal chambers and stuffing boxes. In contrast, the arced groove design of the throat bushings described herein may facilitate cleaning of the seal chamber/stuffing box by forcing grit, solids, and/or dirt through one or more arced grooves back to the pump chamber, making use of the distribution of the velocity vector and the pressure differential in the fluid medium. By allowing the fluid medium to follow its rotational flow pattern, the seal chamber/stuffing box may be cleared of debris in a more continuous, non-interrupted manner, reducing failure. In addition, these drilled straight holes can become blocked with debris, diminishing the clearing action of the device. The arced groove design of the throat bushings described herein does not allow such a blockage to occur, as it is an open channel.

While it is possible for the throat bushing (10) to have a single arced groove (6), it may be advantageous for two or more arced grooves (6) to be provided, for example in the event that one becomes blocked. As will be understood, the throat bushing (1) of FIG. 1 comprises a plurality arced grooves (6) (in this example 4 arced grooves (6) are provided), the substantially semi-helical paths of which are all right-handed directionality. It will be understood that the opposite directionality (i.e. left-handed directionality) may also be possible. The directionality of the one or more arced grooves may be selected so as to match a rotational turn of the rotary shaft, as is described in further detail below.

In the throat bushing (1) of FIG. 1, the openings of the arced grooves (9) extend across the first face (2) from the inner annular surface (8) toward the outer annular surface (4); the exits of the arced grooves (10) extend across the second face (3) from the inner annular surface (8) toward the outer annular surface (4); and the openings of the arced grooves (9) are dimensioned to approach the outer annular surface (4) more closely than the exits of the arced grooves (10). The effect of this illustrated design is that the arced groves of the exemplified throat bushing may define a substantially semi-helical path leading from the first face (2) to the second face (3), which gradually draws closer to the inner bore (5) moving from the first face (2) to the second face (3). In other words, the arced grooves may, in certain embodiments, lead from the first face (2) proximal to the outer annular surface (4), through to the second face (3) proximal to the inner annular surface (8) of the throat bushing inner bore (5).

During pump operation, rotation of the rotary shaft may produce fluid dynamics within the seal chamber or stuffing box which drive fluid contaminants to the outside perimeter of the seal chamber/stuffing box bore in a centrifuge-like manner because of contaminant specific gravity. Particle contaminants may thusly be positioned to easily enter the openings of the arced grooves (9), which may be dimensioned to closely approach the outer annular surface (4) of the throat bushing (1) more closely than do the exits of the arced grooves (10) in certain embodiments as described above. The openings of the arced grooves (9) are located at relatively high-pressure positions during operation, whereas the exits of the arced grooves (10) are located at relatively low-pressure points near the shaft on the impellor side. Contaminants are thusly forced out of the seal chamber/stuffing box and into the pumping chamber, where they may pass out the volute. In the throat bushing (1) of FIG. 1, the throat bushing (1) further comprises an optional outer vent (11) traversing the outer annular surface (4) from the first face (2) to the second face (3), and an optional outer drain (12) traversing the outer annular surface (4) from the first face (2) to the second face (3), the outer drain (12) being located on the outer annular surface (4) substantially opposite the outer vent (11). Such outer vents and outer drains are described in further detail below.

In the illustrated throat bushing (1), the inner annular surface (8) spans between the first face (2) and the second face (3), with at least a portion thereof tapering annularly outward to the first face (2). In the illustrated embodiment, the tapered portion (7) of inner bore (5) of throat bushing (1) progressively narrows from the first face to the second face along this region. This tapered portion (7) is described in further detail below.

As also shown in FIG. 1, the inner annular surface (8) may interface with an optional first annular chamfer (14) formed between the inner annular surface (8) and the first face (2). The inner annular surface (8) of the illustrated throat bushing (1) of FIG. 1 further comprises a shaft clearance portion (15) which spans between the tapered portion (7) of inner annular surface (8) and the second face (3). The shaft clearance portion (15) defines the inner diameter (ID) of the bore of the device and is where the shaft rides with a close tolerance clearance. The inner annular surface (8) of the throat bushing (1) thus tapers from the interface between the shaft clearance portion (15) and the tapered portion (7) up to the first annular chamfer (14). The first face (2) of the throat bushing (1) illustrated in FIG. 1 may include, in further embodiments, an optional annular interface (not shown) which splays outwards from the first face (2) around the outer circumference thereof, replacing second annular chamfer (13). Such annular chamfers and annular interfaces are described in further detail below.

FIGS. 2-5 provide additional views of the throat bushing (1) illustrated in FIG. 1. FIG. 2(A) shows a top plan view, FIG. 3(A) shows a bottom plan view, FIG. 4 shows a side elevational view, and FIG. 5 shows (A) a cross-sectional perspective view and (B) a cross-sectional side view of the throat bushing of FIG. 1. FIGS. 2(B) and 3(B) shows perspective views of the seal-facing and impeller-facing sides, respectively, of the throat bushing of FIG. 1 shown with a rotary shaft (22) passing through its inner bore.

The following examples described throat bushings as described herein applied in seal chamber and stuffing box pump setups. It will be understood that these examples are provided for illustrative purposes, and that teachings provided in these examples are not limited to the particular environments and/or conditions being exemplified.

### Example 1: Throat Bushing and Seal Chamber Setup

FIG. 6 shows a cross-sectional side view of a throat bushing as described herein and illustrated in FIG. 1, positioned in one possible operating environment involving a standard centrifugal pump (20) with a mechanical seal arrangement. FIG. 7 shows an expanded partial cross-sectional side view of the pump seal chamber and throat bushing shown in FIG. 6. As shown, the pump (20) is driven by an electric motor (21), which in turn drives a rotary shaft (22) supported by bearings within a bearing housing (23). The shaft (22) is connected to an impeller (24) at its terminal end. As the impeller (24) is rotated by the shaft, water or other fluid is drawn into the pump housing through a pump inlet (25), and pumped out to the environment through pump outlet (26).

As illustrated in FIG. 6, and in expanded view in FIG. 7, the throat bushing (1) may be placed in the throat of a seal chamber (27), with the pump shaft (22) running through its inner bore (5). Other possible embodiments are also envisioned, in which the throat bushing (1) is placed in different positions between the throat and the seal. The axis of rotation of pump shaft (3) is represented by line A-A shown in FIG. 7. A mechanical seal (28) is positioned at the rear end of the seal chamber (27). Arced grooves (6) formed in the throat bushing (1) provide passageways for particulate matter to be evacuated from the seal chamber (27) to the pump chamber behind the impeller (24).

During pump operation, the arced grooves (6) of throat bushing (1) facilitate the conversion of some of the rotating fluid flow in the seal chamber (27) into an axial flow. This axial flow is created along the outer surface of the seal chamber bore, and is driven towards the throat and away from the seal (28), as represented by arrows in FIG. 6. Particulates and other contaminants are naturally centrifuged to the outside of the seal chamber bore during operation, and the axial flow directs the particulates towards the throat bushing proximal to outer annular surface (4) thereof. The particulates are then evacuated from the seal chamber (27) via the arced grooves (6). This clearing action greatly reduces wear and erosion of the pump shaft/sleeve components, and can also significantly reduce the demand for flush needed to keep the seal chamber clear, thus reducing the amount of water for the process and limiting the amount of effluent to be disposed of and potentially treated. The time between repair and replacement of seal chamber components may also be extended.

As described above, the throat bushing (1) of FIG. 1 comprises a plurality arced grooves (6), the substantially semi-helical paths of which are all right-handed directionality. It will be understood that the opposite directionality (i.e. left-handed directionality) may also be possible. As will be understood, the directionality of the one or more arced grooves may be selected so as to match or complement a rotational turn of the rotary shaft (22). The arced grooves (6) may thus be provided with a directionality to match with the rotational turn of the pump shaft (22), which in this representative case is a right-handed directionality and a clockwise turn, such that the arced grooves (6) direct the rotational fluid flow imparted by the pump shaft (22) from the seal chamber (27) to the pump chamber behind the impeller (24). The directionality of the arced grooves may thus be selected so as to complement the directionality of the turn of the pump shaft (22) and the fluid flow characteristics of the seal chamber or stuffing box.

It will be understood that further modifications may be made to the depth, radius, directionality and positions of the arced grooves (6) based on the intended application.

The outer annular surface (4) of the throat bushing (1) shown in FIG. 1 is designed to interface with the bore of the seal chamber (27) with a tight fit and to a specified depth. As illustrated in FIGS. 1-5, outer annular surface (4) further defines an outer vent (11) at generally the 12 o'clock position, and an outer drain (12) generally at the 6 o'clock position, each running substantially parallel to the axis of the pump shaft (22). Alternatively, the outer vent (11) and/or outer drain (12) may run at an angle slightly offset from the axis of the pump shaft (22). Optionally, although not required, a recess (not shown) may be provided running perpendicularly through the aforementioned outer vent (11), to act as a baffle. When the throat bushing (1) is in position within the seal chamber bore, outer vent (11) and optional baffle may preferably be at or near the top of the seal chamber bore, with the outer drain (12) at or near the bottom thereof.

The determination of whether or not to include an outer vent (11) and/or outer drain (12) will be apparent to those skilled in the art, and will depend upon the desired application of the throat bushing (1). For instance, upon start up, as the equipment fills with fluid, air may be trapped within the seal chamber and forced to the top of the bore. Up to ⅓ of the seal chamber or more may at times be filled with entrapped air. In this situation, as the pump shaft (22) begins to rotate, the air will move from the seal chamber bore to the shaft, and can envelop the seal (28), preventing cooling action provided by the flush. To reduce heat build-up and achieve greater circulation and reduced energy consumption, the outer vent (11) may be provided for the air to vacate the seal chamber (27). Additionally, inclusion of the outer drain (12) may be frequently advantageous to allow contaminated or caustic fluid to exit the seal chamber (27) when the pump is not in operation or in static mode. This may prevent or reduce process crystallization during pump downtime, and since it reduces contaminated or caustic fluid pooling in the bottom of the seal chamber (8), it may also serve as a safety feature for technicians involved in pump maintenance and teardown.

If desired, the throat bushing (1) may be split axially to facilitate ease of installation.

In certain embodiments, as shown in FIGS. 1, 2, and 5, the inner annular surface (8) of the throat bushing (1) includes a tapered portion (7), sloping inwards from the first (seal) face (2) to a position intermediate between the first (seal) face (2) and the second (impeller) face (3). The tapered portion (7) may provide clearance for the shaft during installation, and/or may reduce the amount of particulate that may be trapped between the inner bore (5) and the pump shaft (22). With the tapered portion (7), the particulate may gravitate from the inner bore (5) towards the first face (2) where it is cleared from the seal chamber (27) through the arced groove(s) (6), in a cyclonic manner.

The inner bore (5) of the throat bushing (1) is dimensioned to have a specified clearance from the pump shaft (22), such that the shaft (22) may pass therethrough and rotate freely.

The throat of the seal chamber will typically be machined to a specified depth, and the throat bushing (1) may be dimensioned to be received therein. Accordingly, the first face (2) may, in certain embodiments, be fashioned to define a sloped annular interface (not shown) around the outer edge thereof for interfacing with a ridge or stop within a bore machined in the throat to accommodate the bushing. The annular interface thus butts against the ridge or stop formed in the machined bore of the throat in this particular embodiment.

The throat bushing illustrated in FIG. 6 is particularly adapted for use with a centrifugal pump having a mechanical seal arrangement. It should be understood, however, that the presently described throat bushing is not limited to this exemplary embodiment, and may be modified in several ways to suit the desired application and the configuration of the pump or other rotary fluid equipment.

The throat bushing may be manufactured from any material commonly known to those skilled in the art, and generally depending upon the intended application therefor. For instance, the device may be constructed of the same material as the pump. Alternatively, it may be constructed from stainless steel, brass, bronze, titanium, ceramic materials, durable plastic materials, or any other material that would withstand the forces exerted upon it during pump operation.

It is also envisioned that devices may be manufactured using a bearing material, in which case a tighter shaft clearance may be employed. In such an embodiment, the inner bore (5) of the bushing (1) may be machined with a larger diameter, to allow for a changeable inner bearing sleeve to be pressed therein. As the changeable bearing sleeve gets worn out, it may be replaced with a new sleeve, thus facilitating re-use of the bushing (1).

In certain embodiments, a throat bushing as shown in FIG. 1 may be manufactured by machining with a rounded ball endmill, thereby preventing or reducing formation of sharp machined edges at the arced grooves (6). Generally speaking, grit and particulate may be caught or buildup at sharp machined edges of previous throat bushings, such as in the drilled straight holes that have been described previously, thus blocking or impeding flow and/or clearing action. Such difficulties may be particularly encountered in applications involving dense fibrous fluid medium, such as pulp and paper, wastewater, and slurry applications. Arced groove designs as described herein may reduce or eliminate such issues in certain applications, as they may be formed with rounded or non-sharp edges which are not enclosed in the same way as the aforementioned drilled holes. As well, throat bushings as described herein may, in certain embodiments, also allow for manufacture in one setup, as opposed to multiple setups on a machining center.

### Example 2: Throat Bushing and Stuffing Box Setup

Throat bushings as described herein are not limited to mechanical seal applications, but may also be applied to packing/stuffing arrangements as is illustrated in FIGS. 8 and 9. The described throat bushings may also be used as a bearing material for mixers and agitators (not shown), for example.

FIG. 8 illustrates a second possible operating environment for the throat bushings as described herein, within a centrifugal pump (20) having a stuffing box arrangement. FIG. 9 shows an expanded cross-sectional side view of the stuffing box and throat bushing as shown in FIG. 8. Similar to FIGS. 6 and 7, the pump (20) shown in FIG. 8 is driven by an electric motor (21), which drives a rotary shaft (22) supported by bearings within a bearing housing (23). The shaft (22) is connected to an impeller (24) at its terminal end, and as the impeller (24) is rotated by the shaft, water or other fluid is drawn into the pump housing through a pump inlet (25), and pumped out to the environment through pump outlet (26).

FIG. 8, and the expanded view in FIG. 9, show a throat bushing (1) positioned in the throat of a stuffing box (57), with the pump shaft (22) running through its bore. The axis of rotation of pump shaft (22) is represented by line A-A shown in FIG. 9. As illustrated, there are three rings of stuffing (51) positioned at the rear end of the stuffing box (57), with a lantern ring (56) positioned between the rings of stuffing (51) and the throat bushing (1). However, it will be recognized that there can be various numbers of packing rings employed in a typical stuffing/packing arrangement, and this number is not intended to be limiting. In fact, depending upon thickness, there may be two, three, or more packing rings used together in a system as described herein. Arced grooves (6) formed through the throat bushing (1) provide passageways for particulate matter to be evacuated from the stuffing box (57) to the pump chamber behind the impeller (24).

As with the above-described seal chamber example, the arced grooves (6) as shown in FIGS. 1-5 are formed in the throat bushing (1), so as to lead from the first face (2) on the packing side (also referred to herein as a packing face) through to the second face (3) on the impeller side (also referred to herein as an impeller face). As discussed above, it may be advantageous in certain embodiments for two or more arced grooves (6) to be provided in the throat bushing (1), in the event that one becomes blocked, although it is possible for the throat bushing (1) to include only a single arced groove (6). Four arced grooves (6) are provided in the throat bushing (1) illustrated in FIGS. 8 and 9. The arced grooves (6) of throat bushing (1) in FIG. 8 operates in a similar way to that described with respect to FIG. 6, and facilitate the conversion of some of the rotating fluid flow in the stuffing box (57) into flow out of the stuffing box (57) and into the pump chamber behind the impeller (24).

In the pump (20) illustrated in FIGS. 8 and 9, a lantern ring (56) is included which features at least one flush port (55). The person of skill in the art having regard to the teachings herein will be able to select a suitable lantern ring based on the particular application. An example of a suitable lantern ring (56) may include those described in PCT patent application publication No. WO 2007/059599, the entirety of which is herein incorporated by reference. Lantern rings (56) may be designed to interface with a throat bushing in a similar manner to that described in WO 2007/059599. It is also envisioned that certain packed embodiments of the rotary fluid equipment may be fashioned without a lantern ring. Thus, inclusion of a lantern ring is not required in all possible configurations.

The outer annular surface (4) of the throat bushing (1) shown in FIGS. 8 and 9 is designed to interface with the bore of the stuffing box (57) with a sliding fit which generally allows the bushing to be slid down the pump shaft into the bottom of the stuffing box during installation. The inner bore (5) of the throat bushing (1), on the other hand, is dimensioned to receive the pump shaft (22) with a specified clearance and enabling free rotation of the shaft (22) therein.

Optionally, a first annular chamfer (14) (also referred to herein as an annular clearance relief) may be cut around the edge of the throat bushing (1) at the interface between the inner annular surface (8) and the first face (2). The first annular chamfer (14) may reduce the amount of particulate that may be trapped between the inner annular surface (8) and the pump shaft (22) by allowing the particulate to gravitate from the bore-shaft interface towards the first face (2), where it is cleared from the stuffing box (57) through the arced grooves (6). A shaft clearance portion (15) of the inner annular surface (8) defines the inner diameter (ID) of the bore of the throat bushing (1). The inner annular surface (8) tapers from the interface between the shaft clearance portion (15) and the tapered portion (7) up to the first annular chamfer (14).

Rings of stuffing (51) will typically be positioned behind the lantern ring (56), if present, and secured within the stuffing box (57) by gland follower (50). As illustrated in FIG. 8, there are three rings of stuffing/packing (51), although this number may vary. This arrangement is typical to most centrifugal pump stuffing boxes, although alternate arrangements may also be envisioned.

The throat bushing (1) and lantern ring (56) are described above with reference to FIGS. 8 and 9 as being separate unitary mating pieces, in order to facilitate installation thereof. If desired, however, each piece may be split axially into two pieces to further facilitate the installation process.

Although the invention has been illustrated and described in greater detail with reference to the preferred exemplary embodiment, the invention is not limited to the examples disclosed, and further variations can be inferred by a person skilled in the art, without departing from the scope of protection of the invention.

For the sake of clarity, it is to be understood that the use of “a” or “an” throughout this application does not exclude a plurality, and “comprising” does not exclude other steps or elements.

1. A throat bushing for use in a seal chamber or stuffing box of rotary fluid equipment, said throat bushing comprising:
a first face;
a second face;
an outer annular surface spanning between the first face and the second face and dimensioned to be received with a tight fit within a throat or bore of said seal chamber or stuffing box;
an inner annular surface defining an inner bore extending from the first face to the second face, the inner bore dimensioned to receive a rotary shaft with clearance to permit free rotation of said rotary shaft therein; and
at least one arced groove traversing the inner annular surface from the first face to the second face, the arced groove being open to the inner bore along its length and defining a substantially semi-helical path leading from an opening of the arced groove located on the first face to an exit of the arced groove located on the second face.

2. The throat bushing of claim 1, wherein:
the opening of the arced groove extends across the first face from the inner annular surface toward the outer annular surface;
the exit of the arced groove extends across the second face from the inner annular surface toward the outer annular surface; and
the opening of the arced groove is dimensioned to approach the outer annular surface more closely than the exit of the arced groove.

3. The throat bushing of claim 1, wherein the throat bushing comprises more than one arced groove, the substantially semi-helical paths of which are all left-handed directionality or all right-handed directionality thereby matching a rotational turn of the rotary shaft.

4. The throat bushing of claim 1, wherein the throat bushing comprises an outer vent traversing the outer annular surface from the first face to the second face.

5. The throat bushing of claim 4, wherein the throat bushing comprises an outer drain traversing the outer annular surface from the first face to the second face, the outer drain being located on the outer annular surface substantially opposite the outer vent.

6. The throat bushing of claim 1, wherein the inner annular surface comprises a tapered portion starting within the inner bore between the first face and the second face and tapering annularly outward to the first face.

7. The throat bushing of claim 1, wherein the inner annular surface comprises a first annular chamfer around the interface between the inner annular surface and the first face.

8. The throat bushing of claim 1, wherein the inner annular surface comprises a shaft clearance portion which defines an inner diameter of the inner bore, the ID being dimensioned to receive said rotary shaft with clearance to permit free rotation of said rotary shaft therein.

9. The throat bushing of claim 1, wherein the first face includes a second annular chamfer around the outer circumference thereof.

10. The throat bushing of claim 1, wherein at least a portion of the inner bore is tapered, progressively narrowing from the first face to the second face.

11. The throat bushing of claim 1, wherein the throat bushing is used in a rotary fluid pump.

12. A rotary fluid pump comprising the throat bushing of claim 1.

13. A kit comprising a throat bushing of claim 1.

14. The kit of claim 13, further comprising instructions for installing the throat bushing in a seal chamber or stuffing box of rotary fluid equipment.

15. The kit of claim 13, further comprising a lantern ring paired to the dimensions of the throat bushing for use within the stuffing box of rotary fluid equipment.

16. The kit of claim 13, further comprising one or more stuffing rings for use within the stuffing box of rotary fluid equipment.

17. A method of manufacturing a throat bushing of claim 1, the method comprising machining into the throat bushing at least one arced groove into the inner annular surface thereof using a rounded ball endmill.

18. A method of manufacturing a rotary fluid pump comprising:
installing a throat bushing as defined in claim 1 into the seal chamber or stuffing box of the rotary fluid pump by inserting said throat bushing into a throat of the seal chamber or stuffing box.

19. The method of claim 18, further comprising a step of removing a previously installed throat bushing from the seal chamber or stuffing box of the rotary fluid pump.
